(19) United States
(12) Patent Application Publication
(10) Pub. No.: US 2007/0083001 A1
(43) Pub. Date: Apr. 12, 2007

(54) Method for the production of polymer powders from aqueous polymer dispersions

(75) Inventors: Patrick Amrhein, Hochheim (DE); Axel Weiss, Speyer (DE); Hartwig Voss, Frankenthal (DE); Rainer Nolte, Limburgerhof (DE); Marc Bothe, Limburgerhof (DE); Martin Meister, Neustadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/578,466

(22) PCT Filed: Nov. 5, 2004
(86) PCT No.: PCT/EP04/12515

§ 371 Date: May 5, 2006

(30) Foreign Application Priority Data
Nov. 7, 2003 (DE) 10352479.7

(51) Int. Cl. C08F 214/06

(52) U.S. Cl. 524/567

(57) ABSTRACT

Process for preparing polymer powder from an aqueous polymer dispersion with water-soluble compounds, the fraction of such compounds being smaller than that of said aqueous polymer dispersion and being based on the polymer present in the form of polymer particles insoluble in water, which comprises subjecting the aqueous polymer dispersion to membrane filtration in a first step of the process and to spray drying in a subsequent second step of the process.

The invention relates to a process for preparing polymer powder from an aqueous polymer dispersion with water-soluble compounds, the fraction of such compounds being smaller than that of said aqueous polymer dispersion and being based on the polymer present in the form of polymer particles insoluble in water, which comprises subjecting the aqueous polymer dispersion to membrane filtration in a first step of the process and to spray drying in a subsequent second step of the process.

The preparation of polymer powders from aqueous polymer dispersions often takes place via spray drying of the corresponding aqueous polymer dispersion. However, the water-soluble, non-volatile compounds of the aqueous polymer dispersion remain here within the resultant polymer powder.

However, a wide variety of applications requires polymer powders in which the proportion of water-soluble compounds present is very small.

By way of example, transparent thermoplastic molding compositions composed of polyvinyl chloride (PVC) receive additions of polymeric modifiers which increase the impact strength of these PVC molding compositions.

These polymeric modifiers for improving impact strength (impact modifiers) are often prepared via free-radical-initiated aqueous emulsion polymerization. To ensure that the PVC molding compositions are transparent, the impact modifiers incorporated at contents of up to 40% by weight have a refractive index which is identical with, or at least very similar to, the reflective index of the PVC. For achieving this objective, the prior art discloses a wide variety of partially crosslinked emulsion polymers having two or more phases, based in particular on butadiene and styrene (known as MBS modifiers), or based on styrene, alkyl acrylates and methyl methacrylate (in this connection see by way of example DE-A 2013020, DE-A 2130989, DE-A 2244519, DE-A 2249023, DE-A 2438402, DE-A 2557828, DE-A 3216988, DE-A 3216989, DE-A 3316224, DE-A 3365229, DE-A 3460373, EP-A 50848, EP-A 93854, EP-A 93855, EP-A 124700, EP-A 379086, U.S. Pat. No. 3,426,101, U.S. Pat. No. 3,971,835, U.S. Pat. No. 4,064,197, U.S. Pat. No. 4,145,380, U.S. Pat. No. 4,128,605, U.S. Pat. No. 4,536,548, or U.S. Pat. No. 4,581,414). The abovementioned emulsion polymers are generally precipitated from the aqueous polymer dispersions via addition of precipitants, washed, dried, and homogeneously mixed in the form of powders with PVC powder and with other commonly used auxiliaries to give what is known as a “dry blend”, and converted into the ready-to-use form in a subsequent melting step involving extrusion, injection molding, or calendering.

The water-soluble constituents of the impact modifiers prepared have to be removed, because the optical properties of the impact-modified PVC, such as transparency or color, and its thermal stability, would be adversely affected in particular by the water-soluble constituents deriving from the emulsion polymerization process, e.g. emulsifiers, protective colloids, free-radical initiators, free-radical chain-transfer agents, or oligomeric water-soluble compounds, and also by the precipitants introduced during the precipitation process. The industrial removal-method generally used is precipitation of the impact modifier and separation of the aqueous phase—with resultant removal of the water-soluble constituents—via solid/liquid separation methods such as centrifuging and decanting. To complete the removal process, the remaining impact modifier material is slurried with deionized water, and if appropriate also mixtures composed of deionized water and organic solvent in which the impact modifier is insoluble, and stirred, and the aqueous liquid phase is again removed via centrifuging and decanting. This complicated procedure generally has to be repeated a number of times in order to give a sufficient diminution in the concentration of the water-soluble compounds. The impact modifier is then dried.

The object on which the present invention was based was to provide an improved process which prepares polymer powders, in particular polymers with impact-modifying properties, with a smaller fraction of water-soluble compounds, from aqueous polymer dispersions.

Surprisingly, it has now been found that the object is achieved via the process defined at the outset.

Aqueous polymer dispersions are well-known. These are fluid systems which comprise, as dispersed phase in an aqueous dispersion medium, dispersed polymer clumps composed of mutually entangled polymer chains and known as a polymer matrix or polymer particles. The average diameter of the polymer particles is often in the range from 10 to 1000 nm, frequently from 50 to 500 nm, or from 100 to 300 nm. The solid polymer content of the aqueous polymer dispersions is generally from 20 to 70% by weight.

Aqueous polymer dispersions are in particular obtainable via free-radical-initiated aqueous emulsion polymerization of ethylenically unsaturated monomers. There are many previous descriptions of this method, which is therefore well-known to the person skilled in the art [cf., for example, Encyclopedia of Polymer Science and Engineering, Vol. 8, pages 659-677, John Wiley & Sons, Inc., 1987; D. C. Blackley, Emulsion Polymerisation, pages 155-465, Applied Science Publishers, Ltd., Essex, 1975; D. C. Blackley, Polymer Latices, 2^{nd} Edition, Vol. 1, pages 33-415, Chapman & Hall, 1997; H. Warson, The Applications of Synthetic Resin Emulsions, pages 49-244, Ernest Benn, Ltd., London, 1972; D. Diederich, Chemie in unserer Zeit [Chemistry in our time] 1990, 24, pages 135-142, Verlag Chemie, Weinheim; J. Piirma, Emulsion Polymerisation, pages 1-287, Academic Press, 1982; F. Hölscher, Dispersionen synthetischer Hochpolymerer [Dispersions of high-molecular-weight synthetic polymers], pages 1-160, Springer-Verlag, Berlin, 1969, and the Patent Specification DE-A 40 03 422]. The usual method of free-radical-initiated aqueous emulsion polymerization involves dispersing the ethylenically unsaturated monomers in an aqueous medium, generally with concomitant use of free-radical chain-transfer agents and dispersing agents, such as emulsifiers and/or protective colloids, and polymerizing by means of at least one water-soluble free-radical polymerization initiator.

The inventive process may in particular be carried out using aqueous polymer dispersions whose polymer particles contain, in copolymerized form,
from 50 to 99.9% by weight of esters of acrylic and/or methacrylic acid with alkanols having from 1 to 12 carbon atoms and/or styrene, or
from 50 to 99.9% by weight of styrene and/or butadiene, or
from 50 to 99.9% by weight of vinyl chloride and/or vinylidene chloride, or
from 40 to 99.9% by weight of vinyl acetate, vinyl propionate, vinyl esters of versatic acid, vinyl esters of long-chain fatty acids, and/or ethylene.

According to the invention, use may in particular be made of aqueous polymer dispersions whose polymers contain, in copolymerized form,
from 0.1 to 5% by weight of at least one C3-C6 α,β-monoethylenically unsaturated mono- and/or dicarboxylic acid and/or amide thereof, and
from 50 to 99.9% by weight of at least one ester of acrylic and/or methacrylic acid with alkanols having from 1 to 12 carbon atoms and/or styrene, or
from 0.1 to 5% by weight of at least one C3-C6 α,β-monoethylenically unsaturated mono- and/or dicarboxylic acid and/or amide thereof, and
from 50 to 99.9% by weight of styrene and/or butadiene, or
from 0.1 to 5% by weight of at least one C3-C6 α,β-monoethylenically unsaturated mono- and/or dicarboxylic acid and/or amide thereof, and
from 50 to 99.9% by weight of vinyl chloride and/or vinylidene chloride, or
from 0.1 to 5% by weight of at least one C3-C6 α,β-monoethylenically unsaturated mono- and/or dicarboxylic acid and/or amide thereof, and
from 40 to 99.9% by weight of vinyl acetate, vinyl propionate, vinyl esters of versatic acid, vinyl esters of long-chain fatty acids and/or ethylene.

According to the invention, it is possible to use polymers whose glass transition temperature is from −60 to +150° C., frequently from −40 to +100° C., and often from −20 to +50° C. The glass transition temperature (T_{g}) is the limiting glass transition temperature value to which the transition temperature tends as molecular weight increases, according to G. Kanig (Kolloid-Zeitschrift & Zeitschrift für Polymere, Vol. 190, page 1, equation 1). The glass transition temperature is determined by the DSC method (Differential Scanning Calorimetry, 20 K/min, midpoint measurement, DIN 53 765).

According to Fox (T. G. Fox, Bull. Am. Phys. Soc. 1956 [Ser. II] 1, page 123, and according to Ullmann's Encyclopädie der technischen Chemie [Ullmann's Encyclopedia of Industrial Chemistry], Vol. 19, page 18, 4th Edition, Verlag Chemie, Weinheim, 1980) a good approximation to the glass transition temperature of copolymers which have at most slight crosslinking is given by:
1/T_{g}=x¹/T_{g}¹+x²/T_{g}²+ . . . xⁿ/T_{g}ⁿ,
where x¹, x², . . . xⁿ is the mass functions of the monomers 1, 2, . . . n and T_{g}¹, T_{g}², . . . T_{g}ⁿ are the glass transition temperatures of the respective polymers composed solely of one of the monomers 1, 2, . . . n, in degrees Kelvin. The T_{g} values for the homopolymers of most monomers are known, these being listed, by way of example, in Ullmann's Encyclopedia of Industrial Chemistry, 5th edn., Vol. A21, page 169, Verlag Chemie, Weinheim, 1992; other sources of glass transition temperatures of homopolymers are, by way of example, J. Brandrup, E. H. Immergut, Polymer Handbook, 1^{st} Ed., J. Wiley, New York, 1966; 2^{nd} edn. J. Wiley, New York, 1975 and 3^{rd} edn. J. Wiley, New York, 1989.

The inventive process advantageously uses aqueous polymer dispersions whose polymers have impact-modifying properties in transparent PVC molding compositions. Use may in particular be made of the aqueous polymer dispersions known from the prior art, where the emulsion polymers of these have partial crosslinking and have two or more phases, and have a refractive index identical, or at least similar, to that of transparent PVC. (In this context see, by way of example, DE-A 2013020, DE-A 2130989, DE-A 2244519, DE-A 2249023, DE-A 2438402, DE-A 2557828, DE-A 3216988, DE-A 3216989, DE-A 3316224, DE-A 3365229, DE-A 3460373, EP-A 50848, EP-A 93854, EP-A 93855, EP-A 124700, EP-A 379086, U.S. Pat. No. 3,426,101, U.S. Pat. No. 3,971,835, U.S. Pat. No. 4,064,197, U.S. Pat. No. 4,145,380, U.S. Pat. No. 4,128,605, U.S. Pat. No. 4,536,548, or U.S. Pat. No. 4,581,414).

Depending on the monomers used for the emulsion polymerization process, and on the nature and the amount of the auxiliaries required for the emulsion polymerization process (for example the water-soluble free-radical initiators, emulsifiers, protective colloids, or free-radical chain transfer agents), on the conduct of the polymerization reaction (e.g. procedure, batch size, temperature, conversion), and also on the work-up of the resultant aqueous polymer dispersion (for example reduction in residual contents of unconverted monomers via chemical post-polymerization methods known to the person skilled in the art, or reduction of the amount of volatile constituents via inert gas stripping or steam stripping processes likewise known to the person skilled in the art), the aqueous polymer dispersions obtained comprise up to 20% by weight of water-soluble compounds, based on the polymer present in the form of polymer particles insoluble in water.

For the purposes of this specification, the content of water-soluble compounds in aqueous polymer dispersions, based on the polymer present in the form of polymer particles insoluble in water, is the content as determined by the method stated hereinafter. To determine this, an aliquot of the homogeneous aqueous polymer dispersion is removed in a first step, and dried to constant weight via heating to 140° C./atmospheric pressure (about 1.01 bar absolute). The resultant solid residue can be used to determine the content Rₜₒₜₐₗ (in % by weight) of non-volatile constituents (composed of polymer insoluble in water and water-soluble emulsifiers, protective colloids, free-radical initiators, free-radical chain transfer agents, oligomeric compounds and, if appropriate, other conventional auxiliaries present, such as antifoams, biocides, fragrances, etc.), based on the amount of aqueous polymer dispersion used for the drying process. In a second step, a defined amount of the homogeneous aqueous polymer dispersion is subjected ultracentrifuging until the weight of the polymer particles which are present and insoluble in water causes them to settle out. The ultracentrifuging method is known to the person skilled in the art. (In this context see, by way of example, S. E. Harding et al., Analytical Ultracentrifugation in Biochemistry and Polymer Science, Royal Society of Chemistry, Cambridge, England, 1992, Chapter 10, Analysis of Polymer Dispersions with an Eight-Cell-AUC-Multiplexer: High Resolution Particle Size Distribution and Density Gradient Techniques, W. Mächtle, pages 147-175, or W. Mächtle, Makromolekulare Chemie [Macromolecular Chemistry] 1984 (185), pages 1025-1039). An aliquot is then taken from the clear aqueous supernatant serum and this is likewise dried to constant weight via heating to 140° C./atmospheric pressure (about 1.01 bar absolute). The resultant solid residue can be used to determine the content R_{soluble} (in % by weight) of non-volatile constituents (composed of water-soluble emulsifiers, protective colloids, free-radical initiators, free-radical chain transfer agents, oligomeric compounds and, if appropriate, other conventional auxiliaries present, such as antifoams, biocides, fragrances, etc.), based on the amount of aqueous polymer dispersion used for the ultracentrifuging process. The content C (in % by weight) of water-soluble compounds in aqueous polymer dispersions, based on the polymer present in the form of polymer particles insoluble in water, can now be determined in a simple manner from the following formula:

$$C = \frac{{R}_{soluble} \times 100 \%}{( {R}_{total} - {R}_{soluble} )}$$

The prior art discloses a wide variety of processes which disclose a reduction in the content of, or removal of, water-soluble constituents from aqueous polymer dispersions, for example by means of ion exchangers (in which connection see, by way of example, WO 00/35971 or JP-A 2199130), or of adsorbent solids (M. C. Wilkinson and D. Fairhurst, J. Coll. lnterf. Sci. 79 (1), (1981), pages 272-277).

It is known that the ultrafiltration method can be applied for aqueous polymer dispersions to increase the concentration of what are known as “milky water”, i.e. the very dilute aqueous polymer dispersions produced during the cleaning or flushing of parts of plants during the preparation of aqueous polymer dispersions [in which connection see, by way of example, U.S. Pat. No. 6,248,809, and J. Zahka and L. Mir, Chem. Eng. Progr. 73 (1977), pages 53-55].

Dialysis methods have also been disclosed for the purification of aqueous polymer dispersions. (See, by way of example, R. H. Ottewill and J. N. Shaw, Z. U. Z. Polym. 215(2) (1967), pages 161 et seq., or M. E. Labib and A. A. Robertson, J. Coll. lnterf. Sci. 67 (1978), pages 543 et seq.).

DE-A 2817226 describes the use of a binder based on an aqueous polymer dispersion whose content of water-soluble compounds was reduced via ultrafiltration, for the production of needled floorcoverings.

The membrane filtration method itself—which for the purposes of this specification is intended to mean ultrafiltration, microfiltration, or else crossflow filtration, i.e. the separation of dissolved components of varying molecular weight or the separation of dissolved and undissolved components in a fluid medium—often water—on a suitable porous membrane, where the undissolved components and/or the dissolved components with higher molecular weight which are retained on the membrane (retentate) are separated from the low-molecular-weight dissolved components which pass through the porous membrane together with some of the fluid medium (permeate)—is known in principle to the person skilled in the art (in which connection see, by way of example, T. Melin and R. Rautenbach, Membranverfahren [Membrane processes], Springer Verlag, Berlin, Heidelberg, 2003, M. Cheryan, Ultrafiltration Handbook, Technomic Publishing Company Inc., 1986, or W. M. Samhaber, Chem.-Ing.-Tech. 59 (1987) No. 11, pages 844-850). The dissolved components here which can pass through the membranes may be either organic or inorganic salts or low-molecular-weight compounds, or else water-soluble polymeric organic compounds with an average molar mass ≦100 000 g/mol, known as oligomeric compounds.

For the membrane process it is in principle possible to use porous membranes whose pore diameters are from 1 nm (molecular separation limits about 1000 g/mol) to 0.5 μm (molecular separation limits about 1 000 000 g/mol). For the purification of aqueous polymer dispersions, the porous membranes which have proven particularly successful are those whose pore diameters are from 5 nm (molecular separation limits about 10 000 g/mol) to 200 nm (molecular separation limits about 500 000 g/mol).

In order that the membrane pores do not become blocked by the polymer particles present in an aqueous dispersion, it is advisable for the porous membranes to be used for removing the water-soluble compounds from aqueous polymer dispersions to be those whose pore diameters are ≦50%, ≦20%, or ≦10% of the average particle diameter of the polymer particles which are present in the polymer dispersion to be treated and are insoluble in water. However, depending on the nature of the surface of the membranes and on the polymer constitution of the polymer particles, other membranes which may be used with advantage are those whose pore diameters are approximately the same as the average particle diameter. The average particle diameter in this application is the particle diameter (cumulant z-average; ISO standard 3321) determined via dynamic light scattering.

The porous membranes may be composed of organic polymers, ceramics, metal, carbon, or a combination of these, and have to be stable in the aqueous dispersion medium at the filtration temperature. For mechanical reasons, the porous membranes have generally been applied to a porous single- or multilayer substructure.

Particular preference is given to porous membranes which are composed of hydrophilic materials, such as metal, ceramics, cellulose recycling material, acrylonitrile, hydrophilicized acrylonitrile, hydrophilicized polysulfone, or hydrophilicized polyether sulfone, or hydrophilicized polyether ether ketone.

The shape of the porous membranes used may be flat, or tubular, or that of a multichannel element, or capillary or reel, and appropriate pressure housings permitting separation of retentate and permeate are available for these.

The ideal transmembrane pressures between retentate side and permeate side depend in essence on the diameter of the membrane pores and, respectively, on the molecular separation limits, on the hydrodynamic conditions affecting the build-up of the overlayer on the porous membrane, and on the mechanical stability of the porous membrane at the filtration temperature, and are from 0.2 to 20 bar, preferably from 0.3 to 5 bar, depending on the type of membrane. Higher transmembrane pressures generally lead to higher permeate flow rates. In a case where two or more retentate/membrane/permeate units, known as membrane modules, have been arranged in series, the permeate pressure may be raised so as to lower the transmembrane pressure for each module and thus adjust it appropriately. The membrane filtration temperature depends on the stability of the membrane, and also on the heat resistance of the aqueous polymer dispersion. Higher temperatures generally give higher permeate flow rates. The permeate flow rates achievable depend greatly on the type of membrane and shape of membrane used, on the process conditions, and also on the solid polymer content of the aqueous polymer dispersion. Typically, the permeate flow rates are from 5 to 500 kg/m²h.

In order to decrease the concentration of the compounds dissolved in the aqueous phase of the aqueous polymer dispersions, for example organic or inorganic salts, free-radical initiators, emulsifiers, protective colloids, free-radical chain transfer agents, unconverted monomers, and also oligomeric compounds, the aqueous polymer dispersion is brought into contact at superatmospheric pressure (>1 bar absolute) with a suitable porous membrane, and polymer-free permeate comprising the dissolved compounds is drawn off on the reverse side of the membrane at a pressure which is lower than that on the retentate side. The retentate obtained comprises an increased-concentration polymer dispersion, which has an increased concentration of dissolved compounds. In order that the solid polymer content does not rise excessively, the amount of permeate removed may be replaced continuously or batchwise within the retentate by deionized water. The polymer dispersion obtained from the free-radical-initiated aqueous emulsion polymerization process is advantageously diluted to a solid polymer content of from 10 to 40% by weight, or preferably from 20 to 30% by weight, and this dilute polymer dispersion is subjected to membrane filtration in such a way that the amount of deionized water introduced per unit of time into the aqueous polymer dispersion is equal to the amount of permeate removed, thus keeping the polymer concentration constant.

The dilute aqueous polymer dispersion is generally subjected here to membrane filtration until the proportion of water-soluble substances is ≦3% by weight, preferably ≦2% by weight, and particularly preferably ≦1% by weight or ≦0.5% by weight, in each case based on the polymer present in the form of polymer particles insoluble in water.

Any significant build-up of an overlayer of the polymer particles on the porous membrane surface would lead to a marked fall-off in the permeate flow rate, and in order to avoid such a build-up it is advantageous to set the relative velocity of the aqueous polymer dispersion with respect to the porous membrane at from 0.1 to 10 m/s, for example via pumped circulation of the aqueous polymer dispersion, via mechanical movement of the actual membrane, or via agitation assembly between the membranes.

The membrane filtration process may be carried out batchwise via two or more passes of the aqueous polymer dispersion through one or more membrane modules arranged in parallel, or continuously via one pass through one or more membrane modules arranged in series. The membrane filtration process is often carried out via two or more passes of the aqueous polymer dispersion through a membrane module or via one pass through two or more membrane modules arranged in series.

It is important that, if necessary, the concentration of the dilute aqueous polymer dispersion may be increased again via further removal of permeate and suppressing the feed of deionized water after removal of the water-soluble compounds, via membrane filtration.

The person skilled in the art is likewise aware of spray drying of aqueous polymer dispersions as a stage in a process. This is frequently carried out in a drying tower with the aid of atomizer disks or single- or twin-fluid nozzles at the top of the tower. A hot gas, such as nitrogen or air, is used to dry the aqueous polymer dispersion, the gas being injected into the tower from below or above, but preferably cocurrrently with the aqueous polymer dispersion from above. The temperature of the drying gas at the tower inlet is from about 90 to 180° C., preferably from 110 to 160° C., and at the tower outlet is from about 50 to 90° C., preferably from 60 to 80° C. The polymer powder discharged from the drying tower is cooled to 20-30° C.

The spray drying of the aqueous polymer dispersion is advantageously carried out in the presence of from 0.01 to 10 parts by weight, frequently from 0.05 to 5 parts by weight, and often from 0.05 to 3 parts by weight, of an inorganic antiblocking agent whose average particle size is from 0.001 to 20 μm, based in each case on 100 parts by weight of the polymer present in the form of polymer particles insoluble in water. The antiblocking agent is usually introduced into the drying tower simultaneously with the aqueous polymer dispersion, but at a separate location. By way of example, the addition takes place by way of a twin-fluid nozzle or conveying screw, in a mixture with the drying gas, or through a separate aperture.

The antiblocking agents known to the person skilled in the art generally comprise powders of inorganic solids, with an average particle size of from 0.001 to 20 μm, frequently from 0.005 to 10 μm, and often from 0.005 to 5 μm (based on the method of ASTM C690-1992, Multisizer/100 μm capillary).

By way of example of antiblocking agents, mention may be made of silicas, aluminum silicates, carbonates, such as calcium carbonate, magnesium carbonate, or dolomite, sulfates, such as barium sulfate, and also talcs, calcium sulfate cements, dolomite, calcium silicates, or diatomaceous earth. It is also possible to use a mixture of the abovementioned compounds, for example microscopic intergrowths composed of silicates and of carbonates.

Depending on the nature of their surface, the antiblocking agents may have hydrophobic (water-repellent) or hydrophilic (hydroscopic) properties. A measure of the level of hydrophobic or hydrophilic properties of a substance is the contact angle of a droplet of deionized water on a press specimen of the corresponding antiblocking agent. The greater the contact angle of the water droplet on the surface of the pressed specimen here, the higher the level of hydrophobic properties or the lower the level of hydrophilic properties, and the reverse also applies. In order to decide whether one antiblocking agent is more hydrophobic or more hydrophilic than another, uniform screen fractions (=identical particle sizes or particle size distributions) are prepared from the two antiblocking agents, and identical sizes or size distributions from these screen fractions are used under identical conditions (amount, area, pressure, temperature) to produce compacted specimens with horizontal surfaces. A pipette is used to apply a droplet of water to each pressed specimen, and the contact angle between the pressed specimen surface and water droplet is determined. The greater the contact angle between the pressed specimen surface and water droplet, the higher the level of hydrophobic properties, or the lower the level of hydrophilic properties.

For the purposes of this specification, hydrophilic antiblocking agents are any antiblocking agents which are more hydrophilic than the hydrophobic antiblocking agents used, i.e. whose contact angles are smaller than those of the hydrophobic antiblocking agents used in the spray process.

The contact angle of the hydrophobic antiblocking agents is frequently ≧90°, ≧100°, or ≧110°, while the contact angle of the hydrophilic antiblocking agents is <90°, ≦80°, or ≦70°.

Examples of hydrophilic antiblocking agents used are silicas, quartz, dolomite, calcium carbonate, sodium/aluminum silicates, calcium silicates, or microscopic intergrowths composed of silicates and carbonates, examples of hydrophobic antiblocking agents used are talc (magnesium hydrosilicate with a layer structure), chlorite (magnesium/aluminum/iron hydrosilicate), silicones treated with organochlorosilanes (DE-A 3101413), or in a general sense hydrophilic antiblocking agents which have been coated with hydrophobic compounds, an example being precipitated calcium carbonate coated with calcium stearate.

Depending on the intended use, hydrophilic antiblocking agents are frequently used when the resultant polymer powder is intended for further processing in an aqueous medium, whereas hydrophobic antiblocking agents are often used when the resultant polymer powder is intended for further processing in a hydrophobic medium.

It is significant that in the preparation of polymer powders which are intended for use as impact modifiers in transparent PVC molding compositions, in particular the abovementioned partially crosslinked emulsion polymers having two or more phases and known from the prior art, the spray drying of the corresponding aqueous polymer dispersion is carried out in the presence of from 0.01 to 3 parts by weight, from 0.01 to 2 parts by weight, from 0.01 to 1 part by weight, from 0.01 to 0.8 part by weight, or from 0.01 to 0.5 part by weight, of an inorganic hydrophobic or hydrophilic antiblocking agent whose average primary particle size (according to the producer's information) is from 5 to 50 nm, frequently from 5 to 30 nm, and often from 5 to 20 nm, based in each case on 100 parts by weight of the polymer present in the form of polymer particles insoluble in water.

Suitable antiblocking agents which may be mentioned are the pulverulent hydrophilic Aerosil® grades from Degussa AG, Germany, e.g. Aerosil® 90, Aerosil® 130, Aerosil® 150, Aerosil® 200, Aerosil® 300, Aerosil® 380, Aerosil® MOX 117, with average primary particle size of from 7 to 20 nm, and also hydrophobic Aerosil® grades, e.g. Aerosil® R972, Aerosil® R974, Aerosil® R202, Aerosil® R805, Aerosil® R812, Aerosil® R104, Aerosil® R106, Aerosil® R816, with average primary particle size of from 7 to 16 nm. It is also possible to use aluminum oxide C, titanium dioxide P25, titanium dioxide T805 from Degussa AG, Germany. Other alternatives which may be mentioned are the fumed silicas CAB-O-SIL® TS-530, CAB-O-SIL® TS-720, CAB-O-SIL® TS-610, CAB-O-SIL® M-5, CAB-O-SIL® H-5, CAB-O-SIL® HS-5, and CAB-O-SIL® EH-5 from Cabot GmbH, Germany, and the fumed silicas Wacker HD® H20, Wacker HDK® H2000, Wacker HDK® N20, Wacker HDK® T30 from Wacker-Chemie GmbH.

The inventive process provides a simple and low-cost route to polymer powders from aqueous polymer dispersions with, when comparison is made with these aqueous polymer dispersions with water-soluble compounds, the fraction of such compounds being smaller than that of said aqueous polymer dispersions and being based on the polymer present in the form of polymer particles insoluble in water. In the particular case of the PVC compositions prepared using the partially crosslinked impact modifiers which correspond to the abovementioned prior art and are obtainable according to the invention, the result is an advantageous improvement in thermal stability, weathering resistance, and overall transparency. There is moreover also an advantageous reduction in the yellowness indices and in the haze of the corresponding modified PVC compositions.

The following non-limiting inventive example illustrates the invention.

### INVENTIVE EXAMPLE

1. Aqueous Polymer Dispersion

A mixture composed of 15.6 kg of deionized water, 1.58 kg of a 33% strength by weight aqueous polymer latex (prepared via free-radical-initiated emulsion polymerization of styrene) with a ponderal median particle diameter (D_{W50}) of 30 nm, 0.05 kg of sodium hydrogen carbonate, and 0.56 kg of a solution of 0.16 kg of sodium persulfate in 2.07 kg of deionized water was heated to 80° C. under nitrogen. An emulsion prepared from 23.55 kg of deionized water, 1.16 kg of the sodium salt of a C₁₂-substituted biphenyl ethersulfonate (Dowfax® 2A1, trademark of Dow Chemical Company), 22.96 kg of styrene, and 0.17 kg of 1,4-butanediol diacrylate was added continuously to the mixture at the abovementioned temperature, with stirring (50 rpm) within a period of 90 minutes. Polymerization was then continued for a further 30 minutes. An emulsion composed of 14.53 kg of deionized water, 0.75 kg of Dowfax® 2A1, 18.76 kg of n-butyl acrylate, and 0.22 kg of 1,4-butanediol diacrylate was then added continuously to the reaction mixture, with stirring, within a period of 1 hour. An emulsion prepared from 8.97 kg of deionized water, 0.17 kg of Dowfax® 2A1, 2.04 kg of styrene, and 7.85 kg of methyl methacrylate was then added continuously to the resultant reaction mixture, with stirring, and polymerization was then continued at 80° C. for a further 30 minutes.

During the introduction of the individual monomer emulsions, a total of 1.67 kg of a solution of 0.16 kg of sodium persulfate in 2.07 kg of deionized water was added continuously.

The aqueous polymer dispersion was then cooled to 20-25° C. (room temperature).

The resultant aqueous polymer dispersion had 2.2% by weight content of water-soluble compounds, based on the polymer present in the form of polymer particles insoluble in water. The average particle size was 150 nm.

The content of water-soluble compounds, based on the polymer present in the form of polymer particles insoluble in water (solid polymer content), was determined as stated below. For this, in a first step an aliquot of the homogeneous aqueous polymer dispersion was removed and dried to constant weight by heating to 140° C./atmospheric pressure (about 1.01 bar absolute). The resultant solid residue could be used to determine the content Rₜₒₜₐₗ (in % by weight) of non-volatile constituents, based on the amount of aqueous polymer dispersion. In a second step, a defined amount of the homogeneous aqueous polymer dispersion is subjected to ultracentrifuging until the weight of the polymer particles which are present and insoluble in water causes them to settle out.

For this, about 40 g of the aqueous polymer dispersion are weighed out into a centrifuging tube (Beckmann Optiseal), and the tube with its contents is placed in a preparative rotor (Beckmann SW 28) of a preparative ultracentrifuge (Beckmann XL-80 K). The specimen was the rotated at 26 000 rpm at 25° C. for 12 hours (the corresponding radial acceleration being about 89 320 g). An aliquot was then removed from the clear aqueous supernatant serum, and this was likewise dried to constant weight by heating to 140° C./atmospheric pressure (about 1.01 bar absolute). The resultant solid residue can be used to determine the content R_{soluble} (in % by weight) of non-volatile water-soluble constituents based on the amount of aqueous polymer dispersion used. The content C (in % by weight) of water-soluble compounds in the aqueous polymer dispersion, based on the polymer present in the form of polymer particles insoluble in water, was then determined from the following formula:

$$C = \frac{{R}_{soluble} \times 100 \%}{( {R}_{total} - {R}_{soluble} )}$$

The average diameter of the polymer particles was generally determined at 23° C. via dynamic light scattering on an aqueous dispersion of from 0.005 to 0.01 percent strength by weight by means of a Malvern Instruments, England Autosizer IIC. The average diameter from cumulant evaluation (cumulant z-average) of the measured autocorrelation function (ISO standard 13321) is given.

The weight average particle size D_{w50} for the polymer seed was determined by the analytical ultracentrifuge method [W. Mächtle, Macromolekulare Chemie [Macromolecular Chemistry], Vol. 185 (1984) pages 1025-1039].

2. Ultrafiltration

The resultant aqueous polymer dispersion was diluted with deionized water to a solid polymer content of 21% by weight. 3 kg of the resultant dilute polymer dispersion were subjected to ultrafiltration at 40° C. in a laboratory CR filter from Valmet Raisio, Finland (stationary membrane; shear being provided by means of a blade stirrer immediately above the flat membrane used), the filter having been integrated within a pumped circuit, the membrane used being C030F from Nadir Filtrations GmbH, Germany, composed of cellulose recycling material with a separation limit of 30 000 g/mol. The trans-membrane pressure here was 1 bar (gauge pressure), and the rotation frequency of the blade stirrer was 40 Hz, and the permeate flow rate was from 40 to 60 kg/m²h. The amount of permeate removed was continuously replaced by deionized water. The total amount of permeate removed was 15 kg. The resultant aqueous polymer dispersion had 0.04% by weight content of water-soluble compounds, based on the polymer present in the from of polymer particles insoluble in water.

3. Spray Drying Antiblocking Agent

The antiblocking agent used comprised Aerosil® 200 from Degussa AG, Germany. This comprises a fumed silica whose specific surface area (by a method based on DIN 66131) is about 200 m²/g, and whose average primary particle size (by a method based on ASTM C 690-1992) is 12 nm, and whose compacted bulk density (by a method based on ISO 787-11) is 50 g/l.

Preparation of Spray-Dried Polymer Powder

Spray drying was carried out in a Minor laboratory dryer from GEA Wiegand GmbH (Niro business unit) with twin-fluid atomization and powder deposition in a fabric filter. The tower inlet temperature of the nitrogen was 130° C. and the outlet temperature was 60° C. The amount of dilute aqueous polymer dispersion metered in per hour was 2 kg.

Simultaneously with the dilute aqueous polymer dispersion, 0.1 part by weight of the antiblocking agent, based on 100 parts by weight of the polymer present in the form of polymer particles insoluble in water, was metered continuously into the top of the spray tower by way of a gravimetrically controlled twin screw.

4. PVC Molding Compositions

A PVC molding composition in which the abovementioned polymer powder was present as impact modifier was prepared as described below:

90 parts by weight of PVC (Solvin® 257 RF, from Solvin), 0.3 part by weight of lubricant (Loxiol® G72, from Cognis), 0.8 part by weight of lubricant (Loxiol® G16, from Cognis), 1.1 part by weight of tin stabilizer (Irgastab® 17 MOK, from Ciba), and 25 parts by weight of the polymer powder from 3. were mixed in a LM 5 FU mixer from MTI Mischtechnik Industrieanlagen GmbH. Within a period of 10 minutes, the mixing temperature was increased from room temperature to 130° C., and then was reduced again to room temperature within a period of 10 minutes. To produce a milled sheet, the resultant “dry blend” was placed on a (110 P) two-roll mill from Dr. Collin GmbH and rolled at 170° C. for 8 minutes. The resultant milled sheet was cut to size, placed in compression molds, and compression molded in a 200 P laboratory sheet press from Dr. Collin GmbH at 180° C. and a pressure of 15 bar. The pressure was then increased to 200 bar at the abovementioned temperature, and the pressed sheets were held under these conditions for 5 minutes and finally cooled to room temperature at a pressure of 200 bar. The resultant press sheets had a thickness of 3 mm.

Determination of Transparency

Haze (to ASTM D 1003) and the overall transmittance of the press sheets of thickness 3 mm were determined with the aid of (HazeGard Plus) transparency measurement equipment from Gardner. In the present inventive example, the haze of the press sheets was 9.5% and their total transmittance was 82%.

Determination of Thermal Stability

11 test specimens (10 mm×10 mm) were stamped out from the milled sheet cooled to room temperature. These were stored in a (UT 6200) oven from Heraeus at 180° C. One test specimen was removed every 10 minutes and stapled to a sample card in order to record a visual assessment of the color change as a function of residence time. The result documented was the time in minutes required for the color to change from yellow to dark brown. The thermal stability determined in the present case was 100 minutes.

Determination of Color Values

The color values L*, a*, and b* for the pressed sheets of thickness 3 mm were determined on a white and on a black background (standard set of tiles from Dr. Lange) by a method based on DIN 6167 with the aid of Luci 100 color measurement equipment from Dr. Lange (illuminant: D65, and standard observer: 10°). The DIN 6167 yellowness index (calculated from L*, a*, and b*) was 31 in the present case. The b* value determined with a black background was −4.3.

Weathering Resistance

Artificial weathering of the 3 mm pressed sheets was carried out via Xeno weathering to ISO 4892-2A and DIN 53387, using Cl 4000 Xeno test equipment from Atlas. The weathering was carried out in repeating cycles of 102 minutes of irradiation with light under dry conditions and 18 minutes of irradiation with light and water-spray with a specimen temperature of 65° C. and relative humidity of from 60 to 80%. The irradiation rate was 550 W/m² in the wavelength range from 290 to 800 nm, 3.3 W/m² in the wave-length range from 290 to 320 nm, and 60.5 W/m² in the wavelength range from 320 to 400 nm. The weathered specimens were used for color measurements to DIN 53236 (illuminant: D65; standard observer: 10°) immediately and after 50, 100, 500, and 1000 hours, using CM 3600D equipment from Minolta. The yellowness index after a weathering time of 1000 hours was 82 in the case of the present inventive example.

### COMPARATIVE EXAMPLE

The preparation of the aqueous polymer dispersion, of the polymer powder, and of the PVC molding composition was carried out by a method based on the inventive example, except that no removal of the water-soluble compounds by means of ultrafiltration was carried out.

The total transmittance of the molding compositions of the comparative example was 80% and their haze was 13.0%. The yellowness index to DIN 6167 was 36. The b* value measured on a black background was −4.8. The thermal stability of the press specimens was 70 minutes and the yellowness index measured for a weathering time of 1000 hours was 107.

1. A process for preparing polymer powder from an aqueous polymer dispersion with water-soluble compounds, the fraction of such compounds being smaller than that of said aqueous polymer dispersion and being based on the polymer present in the form of polymer particles insoluble in water, which comprises:
subjecting the aqueous polymer dispersion to membrane filtration in a first step of the process; and
spray drying in a subsequent second step of the process.

2. The process according to claim 1, wherein the polymer has impact-modifying properties in transparent polyvinyl chloride compositions.

3. The process according to claim 1, wherein the aqueous polymer dispersion is subjected to membrane filtration until the content of the water-soluble substances is ≦3% by weight, based on the polymer present in the form of polymer particles insoluble in water.

4. The process according to claim 3, wherein the aqueous polymer dispersion is subjected to membrane filtration until the content of the water-soluble substances is ≦1% by weight, based on the polymer present in the form of polymer particles insoluble in water.

5. The process according to claim 1, wherein the spray drying of the aqueous polymer dispersion takes place in the presence of from 0.01 to 10 parts by weight of an inorganic antiblocking agent with a average particle size of from 0.001 to 20 μm, based on 100 parts by weight of the polymer present in the form of polymer particles insoluble in water.
